(19) United States
(12) Patent Application Publication
(10) Pub. No.: US 2022/0340353 A1
(43) Pub. Date: Oct. 27, 2022

(54) AUTOMATED SYSTEM AND RELATED EQUIPMENT FOR THE PREPARATION AND DISTRIBUTION OF FOOD

(71) Applicants: Luca BERNABEI, Modena (IT); Daniele DEGL'INNOCENTI, Peschiera del Garda (IT); Massimo ZANOTTO, Povegliano Veronese (IT)

(72) Inventors: Luca BERNABEI, Modena (IT); Daniele DEGL'INNOCENTI, Peschiera del Garda (IT); Massimo ZANOTTO, Povegliano Veronese (IT)

(21) Appl. No.: 17/765,743

(22) PCT Filed: Sep. 29, 2020
(86) PCT No.: PCT/IB2020/059098

§ 371 Date: Mar. 31, 2022

(30) Foreign Application Priority Data
Oct. 1, 2019 (IT) 102019000017678

(51) Int. Cl. B65D 81/34; B65B 31/02; H05B 6/80

(52) U.S. Cl. CPC B65D 81/3453; B65B 31/025; H05B 6/80

(57) ABSTRACT

An automated system for the preparation and distribution of food, comprises: at least one supply station of at least one container adapted to contain a plurality of food ingredients; at least one filling station of the at least one container with the food ingredients; at least one pressurization station intended to apply an vacuum to the at least one container; at least one microwave cooking station of the food ingredients inside the at least one container; and a distribution apparatus/system(s)/component(s)/structure(s) (or the like) of the at least one container to an end consumer.

### TECHNICAL FIELD

The present invention relates to an automated system and related equipment for the preparation and distribution of food, particularly for mass catering.

### BACKGROUND ART

The collective and commercial catering provides for the preparation and distribution on a large scale of complete meals for the community.

The systems of known type provide stations for the preparation, cooking and packaging of food, distribution means for the transport to the place of consumption of the prepared dishes, the reactivation of at least part of them and the delivery to the final consumer.

The preparation, storage and reactivation phases of the dishes are crucial for quality and shelf-life.

In particular, the systems and equipment used affect:
the nutritional quality (i.e. energy and nutrient content: carbohydrates, fats, proteins, minerals, vitamins, fibers, etc.);
the functional or nutraceutical quality (i.e. the content of molecules with biological regulatory activity);
the hygienic-sanitary quality (i.e. microbial contamination and the presence of harmful substances that are foreign or formed during industrial processing or cooking);
the organoleptic quality (i.e. the degree of appreciation as perceived by the senses);
the effectiveness and efficiency with which the preparation takes place (i.e. the ability of the process to produce food with the desired qualities at the lowest cost).

At the end of the production process, the properties of the preparations obtained must be preserved in the most suitable way to avoid, in time and space, the loss of quality levels of the raw materials used and of the dishes made.

Often, hours, or even days or months may elapse between the time the food is prepared and the time it is consumed, depending on the method used to preserve the prepared meals.

The systems and equipment of known type do have some drawbacks.

In fact, each of the operations and manipulations necessary for the preparation and distribution of food represent a point of risk for the loss of product quality and, in particular, for the hygienic, nutritional and functional qualities. In addition, the shelf-life of the dish, once it has been portioned, is very short and needs to be consumed quickly to avoid the risk of bacterial contamination.

These problems are very much felt, for example, in hospital catering where the risk of bacterial contamination is very high and dangerous and where there is a tendency to exclude any type of processing and manipulation of food, including washing dishes, within the hospital itself.

In addition, another of the problems of the systems of known type is the inevitable limitation to serving simple, poorly prepared dishes and, therefore, often not appreciated by consumers.

Furthermore, the distribution operation is not always efficient in providing the final consumer with different dishes at the correct temperature; it is frequent, in fact, that the meals served are excessively hot (e.g. in the case of cold cuts, pasta, raw vegetables or fruit) or, on the contrary, not adequately heated (e.g. in the case of pasta or meat).

It is, therefore, strongly felt the need to improve the above mentioned preparation and distribution systems and the available equipment in order to improve the hygienic quality of the food served and, at the same time, the corresponding nutritional, functional and organoleptic properties.

### DESCRIPTION OF THE INVENTION

The main aim of the present invention is to devise an automated system and related equipment for the preparation and distribution of food that allows the hygienic quality of the dishes served to be implemented considerably.

Another object of present invention is to devise an automated system and related equipment for the preparation and distribution of food that allows easily preparing complex dishes thus improving the organoleptic, functional and nutritional properties of the meals served.

Another object of present invention is to devise an automated system and related equipment for the preparation and distribution of food that allows maintaining the quality of the food unchanged for the entire process of preparation and distribution to the final consumer.

Another object of present invention is to devise an automated system and related equipment for the preparation and distribution of food that allows overcoming the above mentioned drawbacks of the prior art within a simple, rational, easy, effective to use and affordable solution.

The objects set out above are achieved by the present automated system for the preparation and distribution of food having the characteristics of claim 1.

The objects set out above are achieved by the present container for the preparation and distribution of food having the characteristics of claim 12.

The objects set out above are achieved by the present cart for the reactivation and distribution of food having the characteristics of claim 16.

The objects set out above are achieved by the present tray for the distribution of food having the characteristics of claim 19.

The objects set out above are achieved by the present equipment for the reactivation and distribution of food having the characteristics of claim 20.

### BRIEF DESCRIPTION OF THE DRAWINGS

Other characteristics and advantages of the present invention will be more evident from the description of a preferred, but not exclusive, embodiment of an automated system and related equipment for the preparation and distribution of food, illustrated by way of an indicative, yet non-limiting example, in the attached tables of drawings wherein:

FIG. 1 is a schematic representation of an embodiment of the automated system according to the invention;

FIG. 2 is an axonometric view of a container according to the invention;

FIG. 3 is an exploded axonometric view of a container according to the invention;

FIG. 4 is an axonometric view of a tray according to the invention;

FIG. 5 is an axonometric view of an embodiment of a cart according to the invention;

FIG. 6 is an axonometric view of a further embodiment of a cart according to the embodiment;

FIG. 7 is a detailed view of the cart in FIGS. 5 and 6.

### EMBODIMENTS OF THE INVENTION

With particular reference to these figures, reference numeral 1 globally indicates an automated system for the preparation and distribution of food.

The automated system 1 according to the invention comprises:
at least one supply station 2 of at least one container 3 adapted to contain a plurality of food ingredients;
at least one filling station 4 of the at least one container 3 with the food ingredients;
at least one pressurization station 5 intended to apply a vacuum to the at least one container 3;
at least one microwave cooking station 6 of the food ingredients inside the at least one container 3;
distribution means 20, 27, 34 of the at least one container 3 to an end consumer.

The automated system 1 allows carrying out all the above mentioned operations limiting as much as possible the intervention of operators, in order to preserve as much as possible the hygienic conditions of food.

In the supply station 2 there is the storage and preparation of the food ingredients and of the containers 3.

The supply station 2 comprises supply means 7 of the at least one container 3 at the point where at least one preparation line 8 is located.

The container 3 comprises:
at least one container body 9 provided with at least one cavity 9a adapted to contain the food ingredients and defining at least one inlet opening 9b adapted to allow the insertion of the food ingredients inside the cavity 9a;
at least one lid 10 adapted to close the inlet opening 9b.

The container 3 according to the invention comprises subdivision means 11 of the cavity 9a which are associable in a removable manner with the container body 9 and adapted to create inside the cavity 9a different compartments intended to accommodate different ingredients.

As shown in FIG. 3, the subdivision means 11 comprise at least one container element 12 associable by interlocking with the container body 9 inside the cavity 9a.

In the present case, the container element 12 is a vessel of smaller dimensions that the container body 9 and it is housed inside the latter.

Appropriately, the container body 9 defines a corresponding housing seat 9c for the container element 12.

The presence of the container element 12 allows, e.g., inserting inside the container 3 different types of food ingredients that make up the same dish, which must be served together but which, at the same time, need to be cooked in separate containers. This is the case, e.g., of pasta and the various seasonings with which pasta can be served.

The presence of the container element 12 allows greater possibility of customization of the dishes, greater practicality in preparing them and greater possibility of preparing elaborate dishes.

By means of the supply means 7, such as e.g. a conveyor belt, the container bodies 9 and, if necessary, the container elements 12 are placed on the preparation line 8.

Specifically, the container elements 12 are positioned inside the respective housing seats 9c defined in the container bodies 9.

The preparation line 8 is of the type of a conveyor belt, a roller conveyor or the like.

The preparation line 8 conveys the container bodies 9 and the container elements 12 to the filling station 4.

The filling station 4 comprises at least one loading device 13 for at least one food ingredient placed at the point where the preparation line 8 is located.

The loading device 13 is adapted to transfer the food ingredient from the supply station 2 to the preparation line 8.

The loading device 13 is arranged on the preparation line 8 so that the food ingredient is loaded directly inside the container body 9 and, if provided, the container element 12.

Conveniently, the loading device 13 is selected from the list comprising an auger device, a conveyor belt, a roller conveyor.

The filling station 4 comprises a plurality of loading devices 13 arranged in succession and on opposite sides with respect to the preparation line 8.

This way, each of the container bodies 9 and of the container elements 12 can be filled with different ingredients depending on the type of course to be prepared.

The filling station 4 is, therefore, able to optimize and speed up the filling operation of the containers 3, even in the case of a high number of different courses being provided.

Afterwards, the container bodies 9 and the container elements 12 continue along the preparation line 8 to the pressurization station 5 for vacuum application.

First, the lid 10 is positioned on the container body 9 to close the inlet opening 9b and, afterwards, the container 3 is placed under vacuum.

The container 3 is provided with a gasket element positioned between the lid 10 and the container body 9 and adapted to isolate the contents of the cavity 9a from the outside.

The pressurization station 5 comprises vacuum generating means 14 comprising at least one vacuum pump and at least one connecting device adapted to connect the vacuum pump to the container 3.

Appropriately, the lid 10 comprises at least one valve element 15 which can be connected to the vacuum generating means 14, as described above, and adapted to allow the formation of a vacuum inside the cavity 9a.

In more detail, the valve element 15 is adapted to operate in conjunction with the connecting device to generate the vacuum inside the container 3.

The valve element 15 also provides a visual signal of the actual pressurization of the container 3.

In fact, if the valve element 15 appears raised with respect to the plane of the lid 10, this is an indication of lack of pressurization, on the contrary, the pressurization is considered to have occurred.

The containers 3 that do not reach a suitable vacuum level are subjected to a new pressurization operation.

Advantageously, the pressurization station 5 comprises closure means 16 of the container 3.

The closure means 16 have the function of also automating the operation of positioning the lid 10 so as to close the container body 9 in order to avoid direct contacts between an operator and the containers 3.

In particular, the closure means 16 coincide with the vacuum generating means 14 and the connecting device is adapted to operate in conjunction with the lid 10 to position the latter on the container body 9.

Conveniently, the lid 10 comprises a gripping area 10a adapted to define a sealed coupling with the connecting device in order to be moved by the latter.

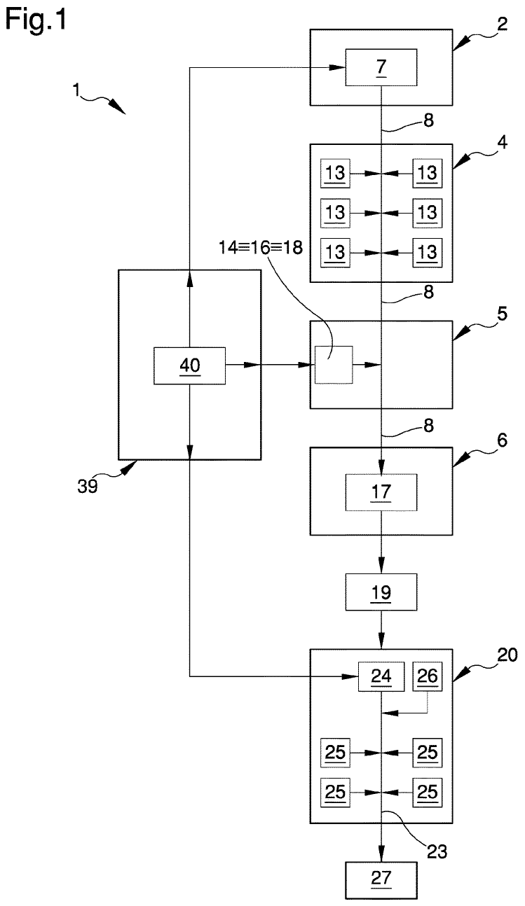

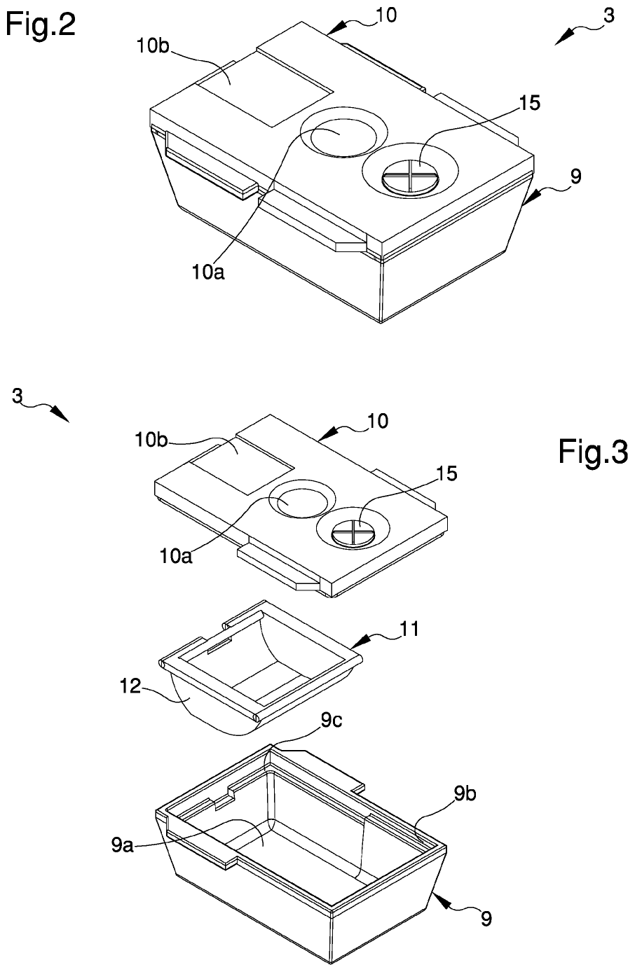

In the embodiment shown in FIG. 1, the container 3 is then moved on the preparation line 8 to the microwave cooking station 6, which comprises a cooking device 17 of the type of a microwave oven.

The container body 9, the container element 12 and the lid 10 are conveniently made of a material which is transparent to microwaves.

The transparent microwave material allows the use of the container 3 in microwave emission devices and allows these to pass through for cooking and heating the food contained therein and, at the same time, prevents the container from heating up and not being handled.

The microwave transparent material is preferably selected from the list comprising tempered glass, ceramic, polypropylene, silicone, a combination thereof. Preferably, the transparent microwave material is tempered glass.

The valve element 15 and the gasket element are, in turn, made of a transparent microwave material, preferably silicone.

It is also important to underline that tempered glass and silicone, in addition to being transparent to microwaves, are also materials with reduced, if not zero, content in allergenic metals such as, e.g., nickel and are therefore extremely suitable for use in the catering industry.

According to an alternative embodiment, not shown, the pressurization station 5 comprises transfer means 18 of the container 3, which have the function of transferring the containers 3 on a special transfer device, of the type, e.g., of a holding structure on wheels.

Advantageously, the transfer means 18 coincide with the vacuum generating means 14 and the connecting device is adapted to operate in conjunction with the lid 10 to raise and move the container 3 under vacuum.

During the transfer operation, the connecting device intercepts the gripping area 10a so as to adhere to the lid 10.

The container 3, which is vacuum packed in this phase, is fully raised and can be moved on the transfer device.

The transfer device has the function of transferring, to the next stations of the automated system 1, the containers 3 that need a rest period before cooking, for example, to allow marinating, or that do not need cooking, for example, in the case of raw vegetables or cold cuts.

This embodiment requires the cooking device 17 to be shaped to contain at least one transfer device.

This way it is possible to carry out a cooking cycle for a plurality of containers 3, optimizing the timing and costs related to this operation.

At the end of cooking, when required, the containers 3 are removed from the cooking device 17 and appropriately labeled for subsequent identification thereof.

The automated system 1, in fact, also comprises an identification station 19 that allows affixing a corresponding identification element to the container 3.

The identification element is, e.g., of the type of a paper label, a barcode, a radio frequency identification device or another suitable means for this purpose and allows associating a container 3 to its contents.

Preferably, the identification element is applied to the lid 10, which comprises an identification housing 10b adapted to accommodate the identification element itself.

At this point, the containers 3 are ready to be distributed to the final consumer.

Conveniently, the distribution means 20, 27, 34 comprise a preparation station 20 of at least one tray 21 adapted to support at least one container 3.

Conveniently, the tray 21 comprises at least one holding surface 22 for at least one container 3.

The tray 21 allows accommodating a plurality of containers 3 that may be combined according to the various types of meal to be served.

The preparation station 20 comprises positioning means 24, 25, 26 of the tray 21 and of at least one container 3 at the point where at least one positioning line 23 is located.

The positioning line 23 is similar to the preparation line 8 described above and may be of the type of a conveyor belt, a roller conveyor, or the like.

The positioning means 24, 25, 26 comprise first positioning means 24 of at least one tray 21 on the positioning line 23.

The first positioning means 24 are of the type of a conveyor belt.

The positioning means 24, 25, 26 also comprise second positioning means 25 of at least one container 3 on the tray 21.

The second positioning means 25 are of the type of an automated mechanical arm.

Advantageously, the preparation station 20 comprises a plurality of the second positioning means 25 adapted to place a plurality of containers 3 on the tray 21.

Appropriately, the second positioning means 25 are arranged in succession and on opposite sides with respect to the positioning line 23.

The second positioning means 25 are provided with a special reader able to recognize the containers 3 thanks to the presence of the identification element and to pick up and place the containers 3 on the tray 21.

The second positioning means 25 allow the preparation of a plurality of trays 21 which are separate on the basis of the meals to be served, by suitably combining the different containers 3.

The positioning means 24, 25, 26 also comprise accessory positioning means 26 adapted to place at least one of bread, cutlery, seasoning and drinks on the tray 21.

At this point, the tray 21 is ready to be served to the end consumer.

For this purpose, the distribution means 20, 27, 34 comprise at least one cart 27 adapted to contain and transport at least one tray 21 provided with at least one of the containers 3.

The cart 27 comprises at least one housing compartment 29a, 29b provided with at least one shelf for at least one tray 21.

In addition, the cart 27 comprises at least one dividing wall 28 positioned inside the housing compartment 29a, 29b and defining at least a first housing compartment 29a and at least a second housing compartment 29b.

The cart 27 comprises at least two side walls provided with one pair of supporting elements 30 mutually defining a shelf for at least one tray 21, wherein the dividing wall 28 is arranged substantially vertical and parallel to the side walls and comprises at least one slit 28a for the insertion of the tray 21 inside the housing compartment 29a, 29b.

The dividing wall 28 operates in conjunction with the supporting elements 30 to define the shelf for the tray 21.

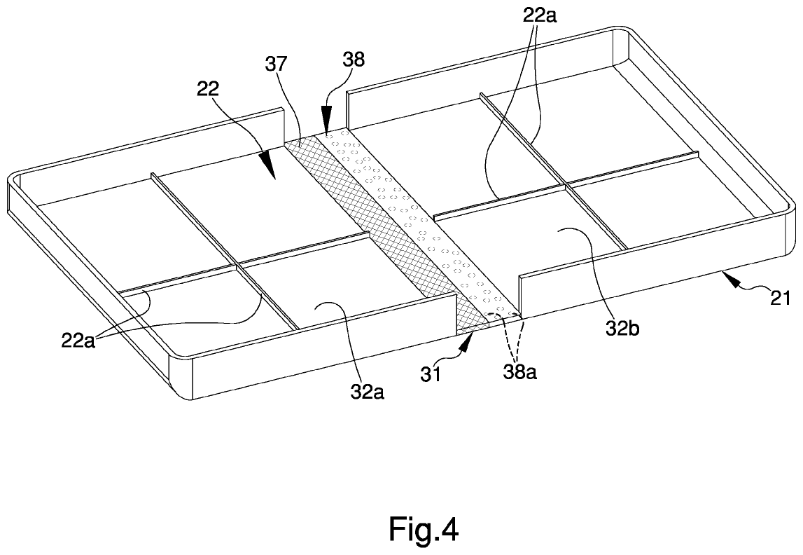

The dividing wall 28 also has the function of separating the two housing compartments 29a and 29b into two areas with different temperatures. As shown in FIG. 4, the tray 21 is suitably provided with at least one separating portion 31 adapted to divide the holding surface 22 into at least a first holding portion 32a and at least a second holding portion 32b.

The tray 21 may be placed inside the cart 27, in the shelf, where the separating portion 31 is insertable into the slit 28a.

When the tray 21 is placed in the cart 27, the first holding portion 32a is inserted in the first housing compartment 29a and the second holding portion 32b is inserted in the second housing compartment 29b, thus allowing the containers 3 to be divided.

This way it is possible to arrange the containers 3 on the tray 21 so that the containers 3 that need to be heated above room temperature can be placed in one of the housing compartments 29a, 29b, while the containers 3 that need to be maintained at or below room temperature can be placed in the other of the housing compartments 29a, 29b.

Conveniently, the holding surface 22 comprises at least one protrusion 22a adapted to divide the holding portions 32a and 32b into a plurality of compartments for the housing of one or more containers 3 according to one or more of the preceding claims.

Specifically, the holding surface 22 comprises two pairs of protrusions 22a arranged in a cross pattern, each defined in each of the holding portions 32a and 32b, and adapted to define 4 compartments in each of the latter.

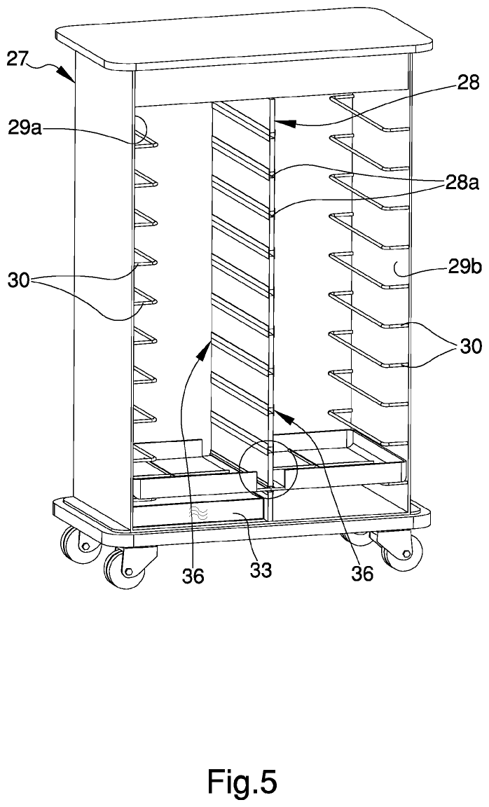

In a preferred embodiment of the automated system 1 according to the invention, shown in FIG. 5, the distribution means 20, 27, 34 comprise reactivation means 33, 34 adapted to heat at least part of the containers 3.

The reactivation means 33, 34 comprise built-in reactivation means 33.

The cart 27 conveniently comprises the built-in reactivation means 33.

In more detail, the built-in reactivation means 33 are arranged inside at least one of the housing compartments 29a, 29b to allow heating the containers 3 contained therein, before delivery to the final consumer.

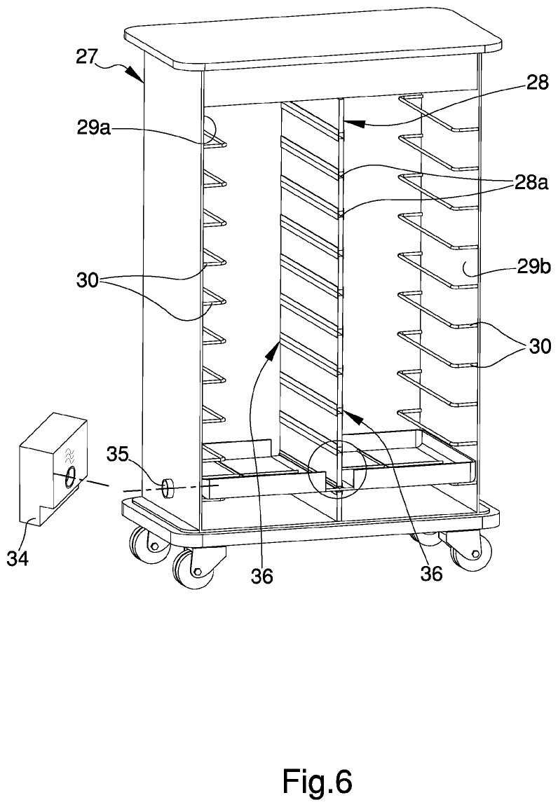

In an alternative embodiment of the automated system 1 according to the invention, shown in FIG. 6, the reactivation means 33 comprise external reactivation means 34 that can be connected to the cart 27.

This embodiment provides that the cart 27 comprises connecting means 35 to connect to the external reactivation means 34.

Through the connecting means 35, the external reactivation means 34 can be connected to at least one of the housing compartments 29a, 29b for heating the containers 3 contained therein.

According to the invention, the reactivation means 33, 34 comprise at least one microwave emitting device.

The microwave emitting device, similarly to the cooking device 17, allows heating the dishes contained in the containers 3 without altering in any way their organoleptic, nutritional and hygienic properties.

Advantageously, the cart 27 comprises insulating means 36 associated with the dividing wall 28 and adapted to maintain separate temperatures inside the housing compartments 29a, 29b.

The slits 28a in the dividing wall 28 generate communication between the two housing compartments 29a, 29b, which could lead to the dispersion of their respective temperatures.

It is, therefore, necessary that, in the presence or absence of the tray 21 in the slit 28a, the maintenance of the respective temperatures in the housing compartments 29a, 29b is ensured in order to preserve food.

The insulating means 36 are positionable between an operating configuration, wherein they operate in conjunction with the tray 21 housed in the shelf, to insulate the housing compartments 29a, 29b, and a home configuration, wherein they obstruct the slit 28a to insulate the housing compartments 29a, 29b.

In other words, the insulating means 36 ensure a constant obstruction of the slit 28a and therefore prevent microwaves or cold from passing between the two housing compartments 29a, 29b.

Conveniently, the insulating means 36 comprise at least one insulating element 36a, 36b positioned inside at least one of the housing compartments 29a, 29b and mounted on the dividing wall 28 at the point where the slit 28a is located.

The insulating element 36a, 36b is of the type of a flexible band mounted on the dividing wall 28 at the point where the slit 28a is located and extending by the entire depth of the dividing wall itself.

The insulating means 36 comprise at least one microwave insulating element 36a made of flexible polymer and metal material.

In particular, the microwave insulating element 36a consists of a wire mesh embedded in the flexible polymeric material, e.g. silicone.

The metal material of the microwave insulating element 36a operates in conjunction with the walls of the corresponding housing compartment 29a, 29b, these too made of metal material, to generate a Faraday cage capable of shielding microwaves.

At the same time, the polymeric material offers adequate thermal insulation.

Specifically, the insulating means 36 comprise a pair of microwave insulating elements 36a, each arranged on opposite sides of the slit 28a.

In the absence of the tray 21, the two microwave insulating elements 36a lie on the same plane and are in mutual contact thus ensuring continuity in the Faraday cage.

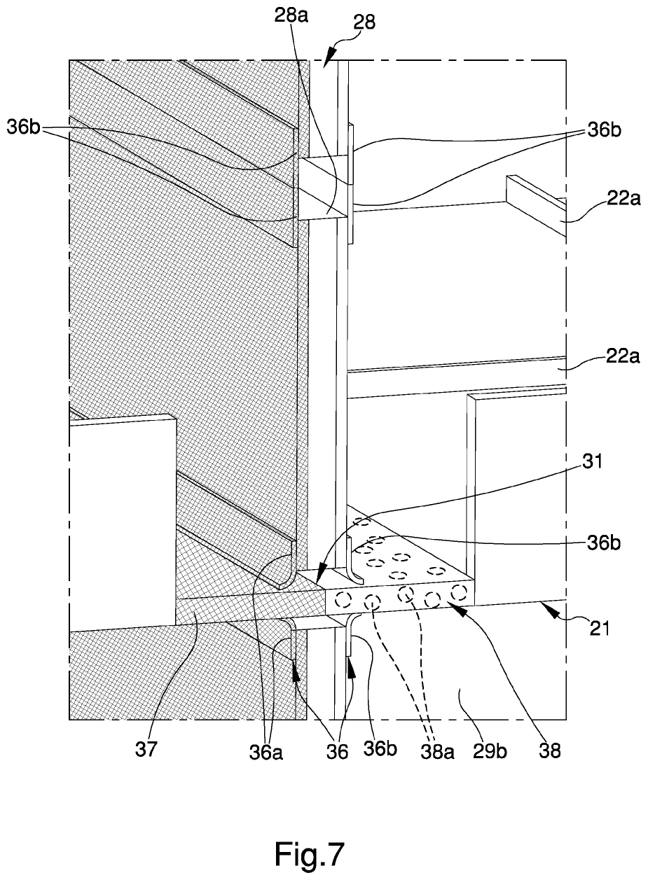

In the presence of the tray 21, the microwave insulating elements 36a partly deform to allow the positioning of the tray 21 in the respective shelf. The tray 21 according to the invention, as shown in FIGS. 4 and 7, comprises microwave shielding means 37 associated with the separating portion 31 and adapted to operate in conjunction with at least one microwave insulating element 36a to shield the microwaves generated inside the at least one housing compartment 29a, 29b.

The microwave shielding means 37 comprise a wire mesh that wraps at least part of the separating portion 31.

More specifically, the wire mesh is wrapped around the separating portion 31, in the area intended to come into contact with the microwave insulating elements 36a.

The tray 21 is conveniently made at least partly of a transparent microwave material.

Preferably, the transparent microwave material is fiberglass.

It cannot however be ruled out that the transparent microwave material is of a different type, the type of a polymeric material.

In this case, the tray 21 also comprises isolation means 38 associated with the separating portion 31 and adapted to thermally isolate the two holding portions 32a, 32b.

In more detail, the isolation means 38 are arranged adjacent to the microwave shielding means 37.

The isolation means 38 comprise a plurality of isolation members 38a embedded at least partly inside the separating portion 31.

The isolation members 38a are of the type of spheres made of ceramic material.

The tray 21 according to the invention allows therefore being effectively used inside the cart 27 and ensuring adequate thermal insulation between the containers 3 stored in the two holding portions 32a, 32b.

The insulating means 36 also comprise at least one thermal insulating element 36b made of a flexible polymeric material.

Similarly to the above, the flexible polymeric material is, e.g., silicone.

The thermal insulating element 36b operates in conjunction with the dividing wall 28 to close the slit 28a and prevent cold air from passing to the other of the housing compartments 29a, 29b.

Specifically, the insulating means 36 comprise a pair of thermal insulating elements 36b, each arranged on opposite parts of the slit 28a.

In the absence of the tray 21, the two thermal insulating elements 36b lie on the same plane and are in mutual contact with each other, while in the presence of the tray 21, the thermal insulating elements 36b partly deform to allow the positioning of the tray 21 in the respective shelf. The cart 27 may also comprise refrigeration means associated with at least one of the housing compartments 29a, 29b.

The refrigeration means allow reducing the temperature of at least one of the housing compartments 29a, 29b in order to preserve the food ingredients contained in the respective containers 3.

The refrigeration means can be conveniently associated with both the housing compartments 29a, 29b in order to allow cooling of both compartments until reactivation and thus ensuring the perfect preservation of the dishes.

The automated system 1 also comprises at least one washing station 39 of at least one container 3.

The washing station 39 comprises at least one washing device 40 provided with means of support for at least one of the at least one container body 9, the at least one container element 12, the at least one lid 10 and the at least one tray 21.

According to a possible embodiment, the washing device 40 is of the type of an ultrasonic washing tank.

The washing station 39 is conveniently connected to at least one of the supply station 2, for the supply of the clean container bodies 9 and of the clean container elements 12, the pressurization station 5, for the supply of the clean lids 10, and the preparation station 20 for the supply of the clean trays 21.

The support means are first loaded and then inserted into the washing device 40 to perform the washing operation.

The support means comprise at least one of:
at least a first basket which is shaped so as to contain at least one container body 9;
at least a second basket which is shaped so as to contain at least one lid 10; and
at least one accessory basket which is shaped so as to contain at least one tray 21.

The support means may also comprise a third basket which is shaped so as to contain at least one container element 12.

After washing, the support means also have the function of transporting their contents to the respective stations 2, 5, 20, for the subsequent preparation and distribution operations.

The present invention also relates to a piece of equipment 3, 21, 27 for the reactivation and distribution of food, which can be used in the automated system 1 according to the invention.

The equipment 3, 21, 27 according to the invention comprises:
at least one container 3 according to the invention, previously described;
at least one tray 21 according to the invention, previously described; and
at least one cart 27 according to the invention, previously described.

The use of the equipment 3, 21, 27 allows maintaining the organoleptic, functional, nutritional and hygienic properties of the dishes for the entire preparation and distribution cycle.

It has in practice been ascertained that the described invention achieves the intended objects and in particular it is underlined that the automated system for the preparation and distribution of food allows implementing considerably the hygienic quality of the dishes served, thus eliminating the risk related to food contact by the operators.

The automated system according to the invention allows easily preparing complex dishes thus improving the organoleptic, functional and nutritional properties of the meals served, especially thanks to the use of microwaves in vacuum containers.

The automated system and the equipment according to the present invention allow maintaining the quality of food for the entire process of preparation and distribution to the final consumer.

1. An automated system for the preparation and distribution of food, the automated system comprising:
at least one supply station of at least one container adapted to contain a plurality of food ingredients;
at least one filling station of said at least one container with said food ingredients;
at least one pressurization station intended to apply a vacuum to said at least one container;
at least one microwave cooking station of said food ingredients inside said at least one container; and
distribution means of said at least one container to an end consumer.

2. The automated system according to claim 1, wherein said supply station comprises supply means of said at least one container at the point where at least one preparation line is located, wherein said container comprises at least one container body adapted to contain said food ingredients and at least one lid adapted to close said container body.

3. The automated system according to claim 1, wherein said filling station comprises at least one loading device for at least one food ingredient placed at the point where said preparation line is located.

4. The automated system according to claim 1, wherein said pressurization station comprises vacuum generating means comprising at least one vacuum pump and at least one connecting device adapted to connect said vacuum pump to said container, said container being provided with at least one valve element adapted to operate in conjunction with said connecting device to generate an vacuum inside said container.

5. The automated system according to claim 2, wherein said pressurization station comprises closure means of said lid to close said container body.

6. The automated system according to claim 5, wherein said closure means coincide with said vacuum generating means, said connecting device being adapted to operate in conjunction with said lid to position the latter on said container body.

7. The automated system according to claim 1, wherein said distribution means comprise a preparation station at least one tray adapted to support said at least one container.

8. The automated system according to claim 7, wherein said preparation station comprises positioning means of said tray and said at least one container at the point where at least one positioning line is located.

9. The automated system according to claim 7, wherein said distribution means comprise at least one cart which is adapted to contain and transport said at least one tray provided with at least one of said containers.

10. The automated system according to claim 9, wherein said distribution means comprise reactivation means adapted to heat at least part of said containers.

11. The automated system according to claim 10, wherein said reactivation means comprise at least one microwave emitting device.

12. A container for the preparation and distribution of food, the container comprising:
at least one container body provided with at least one cavity adapted to contain food ingredients and defining at least one inlet opening adapted to allow said food ingredients to be inserted inside said cavity;
at least one lid adapted to close said inlet opening; and
subdivision means of said cavity which are associable in a removable manner with said container body and adapted to create inside said cavity different compartments intended to accommodate different ingredients.

13. The container according to claim 12, wherein said subdivision means comprise at least one container element associable by interlocking with said container body inside said cavity.

14. The container according to claim 13, wherein said container body, said container element and said lid are made of a material which is transparent to microwaves.

15. The container according to claim 12, wherein said lid comprises at least one valve element connectable to vacuum generating means and adapted to allow the generation of a vacuum inside said cavity.

16. A cart for the distribution of food comprising:
at least one housing compartment provided with at least one shelf for at least one tray;
at least one dividing wall positioned inside said housing compartment and defining at least a first housing compartment and at least a second housing compartment; and
built-in reactivation means adapted to heat at least part of said containers or connecting means to external reactivation means, wherein
said reactivation means comprise at least one microwave emitting device.

17. The cart according to claim 16, further comprising: at least two side walls provided with one pair of supporting elements mutually defining a shelf for at least one tray, wherein said dividing wall is arranged substantially vertical and parallel to said side walls and comprises at least one slit for the insertion of said tray inside said housing compartment, said dividing wall operating in conjunction with said supporting elements to define said shelf; and insulating means associated with said dividing wall and adapted to maintain separate temperatures inside said housing compartments.

18. The cart according to claim 17, wherein said insulating means are positionable between an operating configuration, wherein said insulating means operate in conjunction with said tray housed in said shelf to insulate said housing compartments, and a home configuration, wherein said insulating means obstruct said slit to insulate said housing compartments.

19. A tray for the distribution of food comprising:
at least one holding surface;
at least one separating portion adapted to divide said holding surface into at least a first holding portion and at least a second holding portion;
said tray being placed in the cart according to claim 16, wherein said separating portion is insertable into said slit;
microwave shielding means associated with said separating portion and adapted to operate in conjunction with said at least one microwave insulating element to shield the microwaves generated inside said at least one housing compartment.

20. Equipment for the reactivation and distribution of food, the equipment comprising:
at least one container;
at least one tray according to claim 19; and
at least one cart according to claim 19,
wherein at least one container includes:
at least one container body provided with at least one cavity adapted to contain food ingredients and defining at least one inlet opening adapted to allow said food ingredients to be inserted inside said cavity;
at least one lid adapted to close said inlet opening; and
subdivision means of said cavity which are associated in a removable manner with said container body and adapted to create inside said cavity different compartments intended to accommodate different ingredients.
